(19) United States
(12) Patent Application Publication
(10) Pub. No.: US 2026/0121241 A1
(43) Pub. Date: Apr. 30, 2026

(54) POWER STORAGE DEVICE

(71) Applicant: TOYOTA JIDOSHA KABUSHIKI KAISHA, Toyota-shi (JP)

(72) Inventors: Kunihiro TSUNEKAWA, Toyota-shi (JP); Koki NAKADA, Toyota-shi (JP); Shinya TAKESHITA, Toyota-shi (JP); Naoyuki TAKAHASHI, Toyoake-shi (JP); Ryo KIMURA, Nagoya-shi (JP); Kazuhito KATO, Toyota-shi (JP); Toshihiro SHIMONAKA, Toyota-shi (JP); Kota ICHISAWA, Toyota-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 19/269,533

(22) Filed: Jul. 15, 2025

(30) Foreign Application Priority Data
Oct. 29, 2024 (JP) 2024-189559

(51) Int. Cl. H01M 50/514; H01M 10/613; H01M 10/6552; H01M 50/209; H01M 50/367; H01M 50/507; H01M 50/512; H01M 50/519

(52) U.S. Cl. CPC H01M 50/514; H01M 10/613; H01M 10/6552; H01M 50/209; H01M 50/367; H01M 50/507; H01M 50/512; H01M 50/519

(57) ABSTRACT

A power storage device includes a first power storage cell (power storage cell), a second power storage cell (power storage cell), and a conductor member. Each of the first power storage cell and the second power storage cell includes an electrode terminal near the conductor member. Each of the electrode terminal of the first power storage cell and the electrode terminal of the second power storage cell is connected to the conductor member via a conductive adhesive.

### CROSS-REFERENCE TO RELATED APPLICATION

This application claims priority to Japanese Patent Application No. 2024-189559 filed on Oct. 29, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Chinese Unexamined Patent Application Publication No. 116686151 discloses a power storage device including a plurality of power storage cells fixed in a case (housing cavity). Electrode terminals of each power storage cell are provided to face the bottom wall of the case.

### SUMMARY

In the power storage device described in Chinese Unexamined Patent Application Publication No. 116686151, it is not necessarily easy to connect the power storage cells and conductor members (e.g., busbars) and further to maintain the connection between them.

The present disclosure has been made to address the above issue, and an object thereof is to facilitate connecting power storage cells and conductor members and maintaining the connection between them.

An aspect of the present disclosure provides a power storage device. The power storage device includes a first power storage cell, a second power storage cell, and a conductor member. Each of the first power storage cell and the second power storage cell includes an electrode terminal near the conductor member. Each of the electrode terminal of the first power storage cell and the electrode terminal of the second power storage cell is connected to the conductor member via a conductive adhesive.

According to the present disclosure, it is possible to facilitate connecting the power storage cells and the conductor members and maintaining the connection between them.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overview of a power storage device according to an embodiment of the present disclosure;

FIG. 2 shows the interior of the power storage device according to the embodiment;

FIG. 3 is an end view of the power storage device taken along line III-III in FIG. 2;

FIG. 4 is an end view of the power storage device taken along line IV-IV in FIG. 2;

FIG. 5 shows a connection portion between power storage cells and a wiring board shown in FIG. 2; and

FIG. 6 illustrates a method for connecting the power storage cells and the wiring board shown in FIG. 2.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated. In the drawings referred to in the following description, the X-axis, the Y-axis, and the Z-axis indicate three axes that are perpendicular to each other. Hereinafter, the directions indicated by the arrows of the X-axis, the Y-axis, and the Z-axis are denoted with a plus sign “+,” and the opposite directions are denoted with a minus sign “-”.

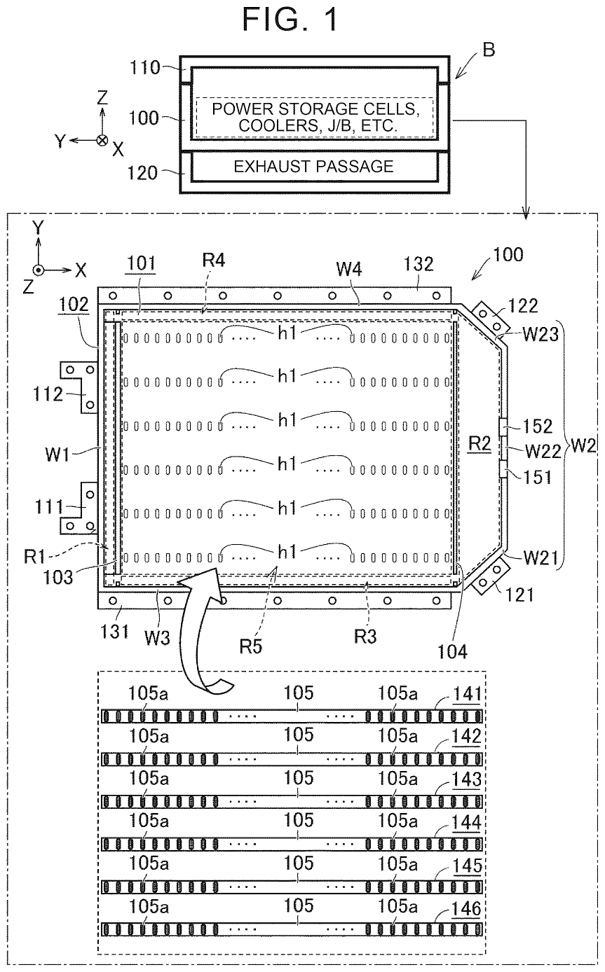

FIG. 1 illustrates an overview of a power storage device according to the present embodiment.

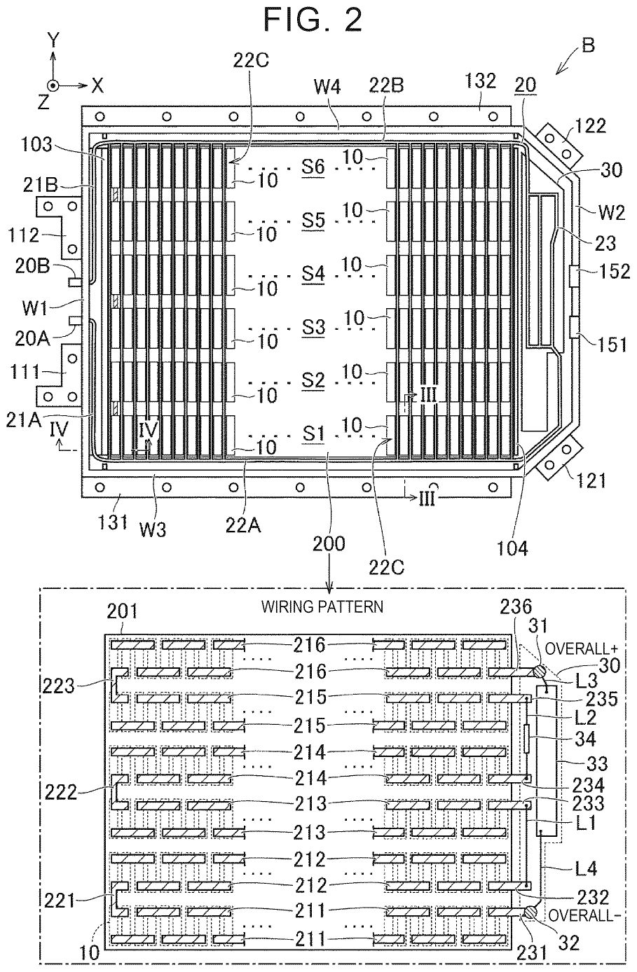

Referring to FIG. 1, a power storage device B according to the present embodiment includes a lower case 100 (first housing member), an upper cover 110 (second housing member), and a common panel 120 (third housing member), and these components serve as a housing for the power storage device B. The lower case 100 is open upward (on the +Z-side), and houses a plurality of power storage cells and various components associated with these power storage cells. As will be described in detail later, the lower case 100 houses the power storage cells, a cooler, a junction box (hereinafter referred to as “J/B”), etc. (see FIG. 2). The upper cover 110 and the common panel 120 are each fixed to the lower case 100. The upper cover 110 is disposed above the lower case 100 and serves as a lid for the lower case 100. The common panel 120 is disposed below (on the −Z-side of) the lower case 100, and serves to reduce shocks on the lower case 100 caused by road surface interference. An exhaust passage is formed between the lower case 100 and the common panel 120.

For example, in the state where the power storage device B is mounted on a vehicle, the −Z-side is downward (downward in the vertical direction), the +Z-side is upward (upward in the vertical direction), the −X-side is toward the front of the vehicle, and the +X-side is toward the rear of the vehicle. The power storage device B may serve as a traction power storage device that is commonly referred to as “battery pack.” The vehicle may be a battery electric vehicle (BEV) or any other type of electrified vehicle (xEV).

The lower part of FIG. 1 shows the lower case 100 in an empty state (a state in which nothing is housed) as viewed from above (+Z-side). The lower case 100 includes a bottom wall 101 (bottom) and a peripheral wall 102 (peripheral portion). The bottom wall 101 includes regions R1 to R5. The peripheral wall 102 includes side walls W1 to W4. The side walls W1, W2, W3, W4 correspond to the ends of the lower case 100 on the −X-side, the +X-side, the −Y-side, and the +Y-side, respectively. The side wall W2 includes side walls W21 to W23. The side walls W21 to W23 are located on the +X-side of the side walls W3, W4 extending in the X-direction. Among these, the side wall W22 is located farthest on the +X side. The side walls W21, W23 are provided with brackets 121, 122, respectively. The side wall W22 is provided with exhaust valves 151, 152. The side wall W22 is connected to the side walls W3, W4 via the side walls W21, W23, respectively. The opposite (−X-side) ends of the side walls W3, W4 are connected to each other via the side wall W1 extending in the Y-direction. The side walls W3, W4 are provided with brackets 131, 132, respectively. The side wall W1 is provided with brackets 111, 112. Each of the side walls W1 to W4 stands from the peripheral edge of the bottom wall 101 toward the +Z-side. The internal space of the lower case 100 is surrounded by the side walls W1 to W4. The power storage device B is connected to the body (e.g., a floor panel) of the vehicle by fastening the brackets 111, 112, 121, 122, 131, 132 to a floor member of the vehicle.

The bottom wall 101 is provided with partition walls 103, 104 extending in the Y-direction. The partition walls 103, 104 may be fastened to the bottom wall 101. The partition wall 104 is located on the +X-side of the partition wall 103. The partition walls 103, 104 stand from the bottom wall 101 toward the +Z-side. The region R5 is a rectangular region located in the central portion of the lower case 100 and is defined by the partition walls 103, 104. The region R5 is a region where a wiring board 200 and power storage stacks S1 to S6 (see FIG. 2) described later are arranged. The region R5 is located between the partition walls 103, 104 (inward of the partition wall 103 and inward of the partition wall 104). Each of the partition walls 103, 104 may be a cross frame.

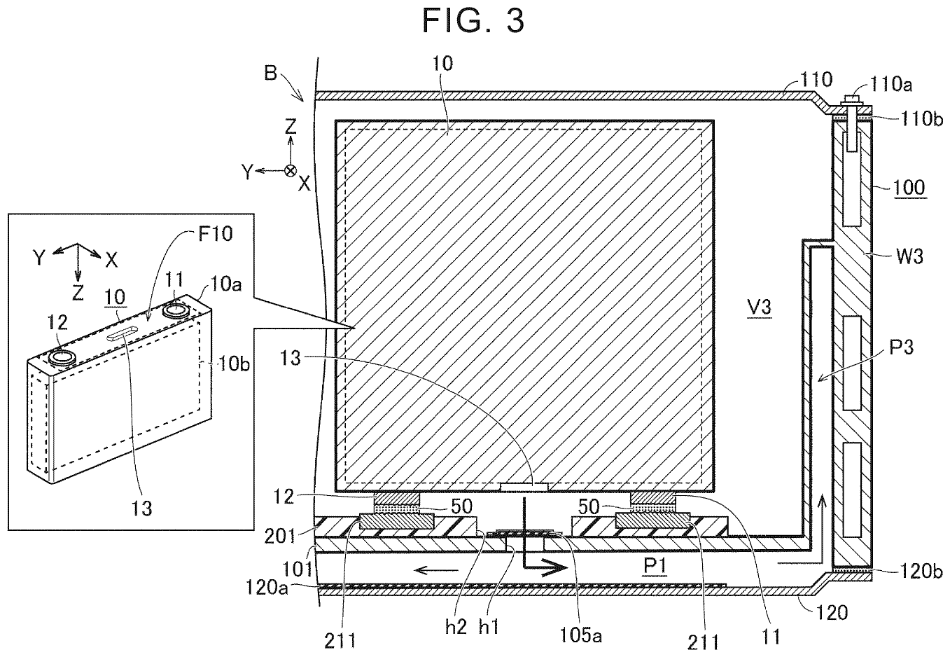

The region R5 has openings h1 at positions where the power storage cells are disposed. Each of the openings h1 is disposed to face a valve 13 (see FIG. 3) of a corresponding one of power storage cells 10 described later in the Z-direction. The openings h1 are arranged in the X-direction to form rows of the openings h1. The number of rows formed in the bottom wall 101 corresponds to the number of power storage stacks. The openings h1 are, for example, long holes that extend through the bottom wall 101. However, the shape of the opening h1 can be changed as appropriate. The openings h1 are formed by, for example, punching.

In the present embodiment, cover members 141 to 146 are provided in the region R5 of the bottom wall 101. All of the openings h1 formed in the bottom wall 101 are thus covered by the cover members 141 to 146. Each of the cover members 141 to 146 includes a base 105 that is elongated in the X-direction, and N lids 105a arranged in the X-direction. In the present embodiment, the number of power storage cells included in one power storage stack is also N. N is, for example, 20 or more and 50 or less. However, the present disclosure is not limited to this, and N may be 2 or more and less than 20, or may be more than 50.

The base 105 may have an adhesive on its one surface (adhesive surface). The base 105 may be, for example, an adhesive tape such as a polypropylene (PP) tape. The N lids 105a are formed on the base 105. In the present embodiment, the lids 105a contain mica. The N lids 105a of each of the cover members 141, 142, 143, 144, 145, 146 are formed to close the openings h1 located below a corresponding one of the power storage stacks S1, S2, S3, S4, S5, S6 (see FIG. 2) described later. The size of the lid 105a is the same as or greater than the size of the opening h1. For example, the N lids 105a may be formed on the base 105 by attaching N pieces of mica foil to the adhesive surface of the base 105. Alternatively, the N lids 105a may be formed on the base 105 by forming N through holes in the base 105 and providing mica foil in each of the through holes. Each of the cover members 141 to 146 is attached to the upper surface (the +Z-side surface) of the bottom wall 101 via, for example, the adhesive surface of the base 105. As described above, the portions of the lower case 100 that face the valves 13 (FIG. 3) of the power storage cells 10 contain mica. Mica is excellent in heat resistance and electrical insulation properties.

The regions R3, R4 are provided on the −Y-side and the +Y-side of the region R5, respectively. The region R1 is provided outward (on the −X-side) of the partition wall 103. The region R2 is provided outward (on the +X-side) of the partition wall 104. The region R2 is a region where a battery circuit unit 30 (FIG. 2) is disposed. The region R2 is located at the end of the lower case 100 on the +X-side and is defined by the partition wall 104 and the side wall W2. In the present embodiment, the bottom wall 101, the peripheral wall 102, and the partition walls 103, 104 are each made of metal. However, the material of these walls can be changed as appropriate.

FIG. 2 shows the interior of the lower case 100 (the interior of the power storage device B) with the upper cover 110 removed as viewed from above. Referring to FIG. 2, the power storage stacks S1 to S6, a cooling device 20, the battery circuit unit 30, and the wiring board 200 are housed between the lower case 100 and the upper cover 110. Each of the power storage stacks S1 to S6 includes N power storage cells 10 arranged in the X-direction. The configuration of each power storage cell will be described in detail later. The wiring board 200 has a wiring pattern for the power storage stacks S1 to S6. The battery circuit unit 30 includes a circuit electrically connected to the power storage stacks S1 to S6. The battery circuit unit 30 may be a single unit, or may include a plurality of units.

The cooling device 20 includes ports 20A, 20B, pipes 21A, 21B extending in the Y-direction, pipes 22A, 22B extending in the X-direction, a plurality of coolers 22C extending in the Y-direction, and a cooling pipe 23. These components are connected in the following order from the upstream side: port 20A, pipe 21A, pipe 22A, cooling pipe 23, pipe 22B, pipe 21B, and port 20B. The pipes 22A, 22B are connected to each other via the coolers 22C (cooling plates) arranged in the X-direction. In each of the power storage stacks S1 to S6, the cooler 22C is disposed between the power storage cells adjacent to each other. The adjacent power storage cells are cooled by a cooling medium flowing through a channel formed inside the cooler 22C. Each cooler 22C has a channel communicating with each of the pipes 22A, 22B. The cooling pipe 23 is configured to cool the battery circuit unit 30.

Referring to FIGS. 1 and 2, the ports 20A, 20B are provided on the side wall W1. The port 20B is located on the +Y-side of the port 20A. The pipes 21A, 21B are disposed in the region R1. The pipes 22A, 22B are disposed in the regions R3, R4, respectively. The cooling pipe 23 is disposed in the region R2. The coolers 22C are disposed in the region R5. The cooling medium supplied from the port 20A to the pipe 21A flows through the pipe 21A toward the −Y-side. The cooling medium that has entered the pipe 22A from the pipe 21A flows through the pipe 22A toward the +X-side, namely toward the cooling pipe 23, and also flows into the channels in the coolers 22C. The cooling medium that has entered the coolers 22C from the pipe 22A flows toward the +Y-side, namely toward the pipe 22B, while cooling the power storage stacks S1 to S6. The cooling medium that has entered the cooling pipe 23 from the pipe 22A flows toward the +Y-side, namely toward the pipe 22B, while cooling the battery circuit unit 30. The cooling medium that has entered the pipe 22B from the coolers 22C or the cooling pipe 23 flows through the pipe 22B toward the −X-side, namely toward the pipe 21B. The cooling medium then flows through the pipe 21B toward the −Y-side and flows out from the port 20B. The cooling medium may be a liquid (such as water, oil, or antifreeze solution) or a gas.

In the present embodiment, the wiring board 200 is disposed on the +Z-side of the bottom wall 101, and the power storage stacks S1 to S6 are disposed on the +Z-side of the wiring board 200.

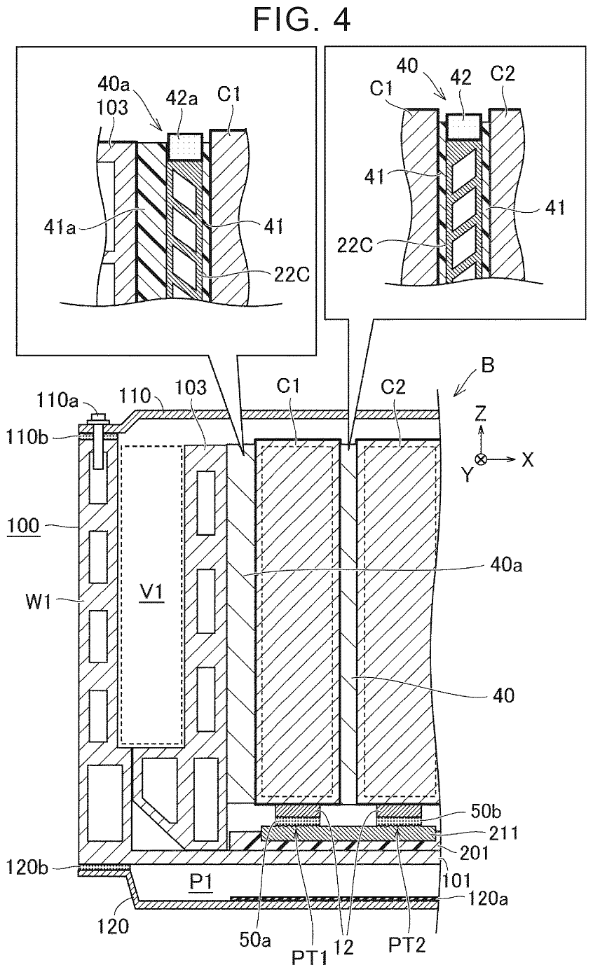

FIGS. 3 and 4 are end views of the power storage device B taken along lines III-III and IV-IV in FIG. 2, respectively. A perspective view of the power storage cell 10 is shown on the left side of FIG. 3.

As shown in the perspective view on the left side of FIG. 3, the power storage cell 10 includes a case 10a and an electrode assembly 10b housed in the case 10a. The case 10a is a rectangular parallelepiped case. The electrode assembly 10b may include one or more windings (e.g., two windings). The winding has a structure in which, for example, a cathode sheet and an anode sheet are wound with a separator interposed therebetween. Each of the cathode sheet and the anode sheet includes an electrode foil and an active material layer. The power storage cell 10 is a secondary cell such as a lithium-ion cell, a nickel metal hydride cell, or a sodium-ion cell. In the present embodiment, a liquid lithium-ion cell is used as the power storage cell 10. The case 10a contains an electrolyte solution together with the electrode assembly 10b. The secondary cell may be of any type, and may be, for example, an all-solid-state secondary cell. A stack (e.g., a stack in which a cathode sheet and an anode sheet are stacked with a separator interposed therebetween) may be used instead of the winding.

The power storage cell 10 has electrode terminals 11, 12 and the valve 13 on the same surface. Specifically, the electrode terminals 11, 12 and the valve 13 are provided on a surface F10 of the case 10a. The surface F10 corresponds to an end face of the power storage cell 10 on one side in the height direction (Z-direction). The valve 13 serves as an exhaust valve. The case 10a is basically maintained in a sealed state. However, when the pressure inside the case 10a exceeds a first reference value, the valve 13 opens to reduce the pressure inside the case 10a. The electrode terminal 11 and the electrode terminal 12 are respectively electrically connected to the cathode sheet and the anode sheet of the electrode assembly 10b, and respectively serve as a cathode terminal and an anode terminal.

The portions of the case 10a that surround the electrode terminals 11, 12 may be made of an insulating material, and the other portions of the case 10a may be made of metal. However, the present disclosure is not limited to this, and the case 10a may be made of any material.

In the present embodiment, the power storage cells included in the power storage stacks S1 to S6 have the same configuration (the configuration shown in FIG. 3). Forming the power storage stacks S1 to S6 using the same type of power storage cells 10 facilitates the manufacturing of the power storage device B and reduces the manufacturing cost. However, the present disclosure is not limited to this, and each power storage stack may include a plurality of types of power storage cells. The number of power storage stacks can be changed as appropriate. The number of power storage stacks may be one or more.

The power storage cells included in the power storage stacks S1 to S6 are electrically connected by the wiring pattern of the wiring board 200. The wiring board 200 is, for example, a panel with a wiring pattern. An example of the wiring pattern of the wiring board 200 is shown in the lower part of FIG. 2.

Specifically, the wiring board 200 includes a rectangular insulating substrate 201, a plurality of conductor members 211, a plurality of conductor members 212, a plurality of conductor members 213, a plurality of conductor members 214, a plurality of conductor members 215, a plurality of conductor members 216, conductor members 221 to 223, and conductor members 231 to 236. The insulating substrate 201 is made of, for example, resin.

Each of the conductor members 211 electrically connects the power storage cells included in the power storage stack S1. Each of the conductor members 212 electrically connects the power storage cells included in the power storage stack S2. Each of the conductor members 213 electrically connects the power storage cells included in the power storage stack S3. Each of the conductor members 214 electrically connects the power storage cells included in the power storage stack S4. Each of the conductor members 215 electrically connects the power storage cells included in the power storage stack S5. Each of the conductor members 216 electrically connects the power storage cells included in the power storage stack S6.

The conductor member 221 electrically connects the power storage stacks S1, S2. The conductor member 222 electrically connects the power storage stacks S3, S4. The conductor member 223 electrically connects the power storage stacks S5, S6. The conductor members 231, 232, 233, 234, 235, 236 electrically connect the power storage stacks S1, S2, S3, S4, S5, S6 to the battery circuit unit 30, respectively.

In the present embodiment, the wiring pattern of the wiring board 200 is formed by the above conductor members. Each of the conductor members 211 to 216, 221 to 223, 231 to 236 is, for example, a plate-shaped member made of metal. Each of the conductor members 221 to 223 may be a U-shaped plate member. Each conductor member may be a busbar. In the present embodiment, each of the conductor members is fixed in a corresponding one of recesses formed in the surface (+Z-side surface) of the insulating substrate 201. The lower part of each conductor member is embedded in the insulating substrate 201. However, the recesses (steps) for the conductor members need not be formed in the surface of the insulating substrate 201. Each conductor member may be joined to a flat surface of the insulating substrate 201. Each conductor member may be made of any material and may have any shape.

The wiring board 200 is electrically connected to the battery circuit unit 30. As shown in FIG. 2, the battery circuit unit 30 includes an overall positive terminal 31, an overall negative terminal 32, a J/B 33, a fuse 34, and electrical wires L1 to L4. The overall positive terminal 31 is located at the end on the cathode side of all the power storage stacks S1 to S6 (all the power storage cells). The overall negative terminal 32 is located at the end on the anode side of all the power storage stacks S1 to S6 (all the power storage cells). The electrical wire L1 electrically connects the conductor member 232 and the conductor member 233. The electrical wire L2 electrically connects the conductor member 234 and the conductor member 235. The fuse 34 is provided on the electrical wire L2. The conductor member 236 is connected to the overall positive terminal 31. The electrical wire L3 electrically connects the overall positive terminal 31 and the J/B 33. The conductor member 231 is connected to the overall negative terminal 32. The electrical wire L4 electrically connects the overall negative terminal 32 and the J/B 33. The J/B 33 houses various electrical devices. The J/B 33 may include at least one of a relay, a fuse, a resistive element, a current sensor, and a connector (e.g., a connector to an in-vehicle charger). The battery circuit unit 30 may further include either or both of a battery management system (BMS) and an electronic control unit (ECU).

The partition wall 104 may have openings for passing the conductor members 231 to 236 therethrough. Alternatively, an electrical wire (e.g., a cable) connected to the wiring board 200 may be passed above the partition wall 104 and connected to the battery circuit unit 30. The partition walls 103, 104 need not be provided. Either or both of the partition walls 103, 104 may be omitted.

The power storage stacks S1 to S6 each include the same number of power storage cells, and are disposed such that the positions of the power storage cells are aligned among the power storage stacks S1 to S6. Accordingly, each set of six power storage cells 10 arranged in the Y-direction forms a row (row in the Y-direction). The rows are arranged in the X-direction. A total of “6×N” power storage cells 10 are arranged in a matrix with six rows in the Y-direction and N columns in the X-direction. In the wiring pattern shown in FIG. 2, a plurality of parallel-connected units is connected in series. The N power storage cells 10 are disposed such that the positional relationship between the electrode terminal 11 (cathode terminal) and the electrode terminal 12 (anode terminal) is reversed every two power storage cells 10. Each of the conductor members 211 to 216 connects every two power storage cells of its corresponding power storage stack in parallel and connects the resulting parallel-connected units (the power storage cells connected in parallel) in series. How the power storage cells are connected can be changed as appropriate. For example, the number of power storage cells connected in parallel may be three or more, instead of two. All the power storage cells may be connected in series instead of forming the parallel-connected units.

The insulating substrate 201 of the wiring board 200 has openings h2 shown in FIG. 3 at the same positions in an X-Y plane as the openings h1 (FIG. 1). The number of openings h2 is the same as the number of openings h1 (6×N), and each of the openings h2 faces the valve 13 of a corresponding one of the power storage cells 10 in the Z-direction. The openings h2 are, for example, long holes that extend through the insulating substrate 201. The openings h2 have a larger dimension in the X-Y plane than the openings h1 (FIG. 1). In the X-Y plane, each opening h1 is located inward of a corresponding opening h2. As shown in FIG. 3, each opening h2 is connected to a corresponding opening h1 via a corresponding lid 105a. The openings h2 are formed by, for example, punching.

In the manufacturing of the power storage device B, for example, after the wiring board 200 is installed in the lower case 100, the power storage stacks S1 to S6 are mounted on the wiring board 200 with the surfaces F10 of the power storage cells oriented downward in the vertical direction. The battery circuit unit 30 is connected to the wiring board 200, and the cooling device 20 is installed in the lower case 100. As a result, the interior of the lower case 100 is in the state shown in FIG. 2. The coolers 22C of the cooling device 20 may be installed in the lower case 100 together with the power storage stacks S1 to S6. Thereafter, the remaining parts of the cooling device 20 may be placed in the lower case 100, and each of the pipes 22A, 22B may be connected to the coolers 22C. Each of the wiring board 200 and the battery circuit unit 30 may be fixed to the lower case 100 by an adhesive (e.g., a silicone adhesive).

As shown in FIGS. 3 and 4, the upper cover 110 is joined to the upper surfaces (+Z-side surfaces) of the side walls W1 to W4 (only the side walls W1, W3 are shown in FIGS. 3 and 4) via, for example, an adhesive 110b, and is further fastened by bolts 110a. The common panel 120 is joined to the lower surfaces (−Z-side surfaces) of the side walls W1 to W4 via, for example, an adhesive 120b. Although not shown in FIG. 3, the pipe 22A shown in FIG. 2 is disposed in a space V3 between the side wall W3 and the power storage cells 10 located at the −Y-side end in the lower case 100. Although not shown in FIG. 4, the pipe 21A shown in FIG. 2 is disposed in a space V1 between the side wall W1 and the partition wall 103 in the lower case 100.

An exhaust passage P1 is formed between the bottom wall 101 of the lower case 100 and the common panel 120. The side walls W1 to W4 are hollow. As shown in FIG. 3, an exhaust passage P3 is formed inside the side wall W3. Although not shown in the figures, an exhaust passage is also formed inside each of the side walls W2, W4 in a manner similar to that of the exhaust passage P3 of the side wall W3. These exhaust passages communicate with each other. The side wall W2 has exhaust holes connected to the exhaust valves 151, 152 (FIG. 2). These exhaust holes communicate with the exhaust passage.

When the pressure inside the power storage cell 10 exceeds the first reference value, the valve 13 opens as shown in FIG. 3. As a result, a hole is formed in the lid 105a facing the valve 13 due to the pressure and heat of gas discharged from inside the power storage cell 10 through the valve 13. The gas discharged from the power storage cell 10 passes through the hole and flows into the exhaust passage P1. Each of the exhaust valves 151, 152 shown in FIG. 2 opens when the pressure in the exhaust passage exceeds a second reference value. The second reference value may be a pressure value lower than the first reference value. The exhaust valves 151, 152 are, for example, check valves. When either or both of the exhaust valves 151, 152 open, gas in each exhaust passage flows toward the open exhaust valve(s) and is exhausted to the outside of the power storage device B through that exhaust valve(s). The thickness of each lid 105a provided on the lower case 100 (FIG. 1) is set to a thickness small enough that a hole is formed when the valve 13 facing the lid 105a opens (e.g., when the valve opens in a manner that causes ignition).

A mica layer 120a (e.g., mica foil) is provided on the inner (+Z-side) surface of the common panel 120. The mica layer 120a may be provided to overlap all of the lids 105a in the X-Y plane. The mica layer 120a protects the common panel 120 from substances (gas, electrolyte solution, debris, etc.) discharged from the power storage cells 10 through the lids 105a.

As shown in FIG. 4, in each power storage stack, an intermediate member 40 is provided between two power storage cells 10 adjacent to each other in the X-direction, and an extremity member 40a is provided outward of the power storage cell 10 located at the end in the X-direction.

The intermediate member 40 includes the cooler 22C shown in FIG. 2, two insulating pads 41, and two shock absorbing members 42 (only one is shown). Each of the two insulating pads 41 may be a resin film. Each of the two insulating pads 41 is located between the cooler 22C and the power storage cell 10. The shock absorbing members 42 are located at both ends of the intermediate member 40 in the Z-direction and suppress transmission of shocks to the cooler 22C. Although FIG. 4 shows only the end of the intermediate member 40 on the +Z-side, the end on the −Z-side has the same structure.

The extremity member 40a includes the cooler 22C shown in FIG. 2, an insulating pad 41, an insulating pad 41a, and two shock absorbing members 42a (only one is shown). The extremity member 40a basically has the same structure as the intermediate member 40. In the extremity member 40a, one of the two insulating pads 41 in the intermediate member 40 is changed to the insulating pad 41a thicker than the insulating pad 41. The insulating pad 41a is located outward (on the partition wall 103 side) of the cooler 22C. This suppresses transmission of external shocks to the power storage unit (power storage stacks S1 to S6). The shock absorbing members 42a are located at both ends of the extremity member 40a in the Z-direction and suppress transmission of shocks to the cooler 22C. Although FIG. 4 shows only the end of the extremity member 40a on the +Z-side, the end on the −Z-side has the same structure. Although FIG. 4 shows only the extremity member 40a disposed between the partition wall 103 and the power storage cell 10 located at the end on the −X-side, the extremity member 40a is also provided between the partition wall 104 and the power storage cell 10 located at the end on the +X-side.

As shown in FIGS. 3 and 4, each of the power storage cells housed in the lower case 100 includes the electrode terminals 11, 12 on the −Z-side (wiring board 200 side). The electrode terminals 11, 12 of each power storage cell are connected to any of the conductor members of the wiring board 200 via a conductive adhesive 50. With this configuration, the electrode terminals of each power storage cell and the conductor members of the wiring board 200 can easily be connected to each other. Further, the electrical connection between them is maintained by the electrical conductivity and adhesiveness of the conductive adhesive 50. The joining with the conductive adhesive has a wide tolerance to misalignment.

Hereinafter, the power storage cell 10 located on the −X-side (partition wall 103 side) out of the two power storage cells 10 shown in FIG. 4 will be referred to as “power storage cell C1,” and the power storage cell 10 located on the +X-side out of the two power storage cells 10 shown in FIG. 4 will be referred to as “power storage cell C2.” The power storage cell C1 and the power storage cell C2 are examples of the “first power storage cell” and the “second power storage cell” according to the present disclosure, respectively.

Referring to FIG. 4, the power storage cells C1 and C2 are arranged in a direction (X-direction) perpendicular to the vertical direction (Z-direction). The electrode terminal 12 of the power storage cell C1 and the electrode terminal 12 of the power storage cell C2 are connected to the same conductor member 211 while being oriented vertically downward. A surface of the electrode terminal 12 of the power storage cell C1 on the −Z-side (hereinafter referred to as “first surface”) has been subjected to roughening treatment, for example, by etching. A surface of the electrode terminal 12 of the power storage cell C2 on the −Z-side (hereinafter referred to as “second surface”) has also been subjected to roughening treatment, for example, by etching. On the surface (+Z-side surface) of the conductor member 211, a portion PT1 (first portion) to which the electrode terminal 12 of the power storage cell C1 is connected and a portion PT2 (second portion) to which the electrode terminal 12 of the power storage cell C2 is connected have also been subjected to roughening treatment, for example, by etching. The portion PT1 of the conductor member 211 is a portion facing the electrode terminal 12 of the power storage cell C1 in the Z-direction. The portion PT2 of the conductor member 211 is a portion facing the electrode terminal 12 of the power storage cell C2 in the Z-direction. Each portion that has been subjected to the roughening treatment has a greater surface roughness than a portion that has not been subjected to the roughening treatment.

The first surface of the electrode terminal 12 of the power storage cell C1 is connected to the portion PT1 of the conductor member 211 via the conductive adhesive 50 (more specifically, a first conductive adhesive 50a in FIG. 4). The second surface of the electrode terminal 12 of the power storage cell C2 is connected to the portion PT2 of the conductor member 211 via the conductive adhesive 50 (more specifically, a second conductive adhesive 50b in FIG. 4). By subjecting each of the portions PT1 and PT2 of the conductor member 211 to the roughening treatment, the joining strength between each portion and the conductive adhesive 50 is improved. Each of the portions PT1 and PT2 may be formed roughly to the extent that an anchor effect is exhibited. By subjecting each of the first surface of the electrode terminal 12 of the power storage cell C1 and the second surface of the electrode terminal 12 of the power storage cell C2 to the roughening treatment, the joining strength between each of the first surface and the second surface and the conductive adhesive 50 is improved. Each of the first surface and the second surface may be formed roughly to the extent that the anchor effect is exhibited.

The roughening treatment is not limited to etching. For example, minute projections and recesses may be formed on each of the portions PT1 and PT2 and the first and second surfaces by plating or anodizing. Different types of roughening treatment may be used for the electrode terminals of the power storage cells 10 and the conductor members of the wiring board 200.

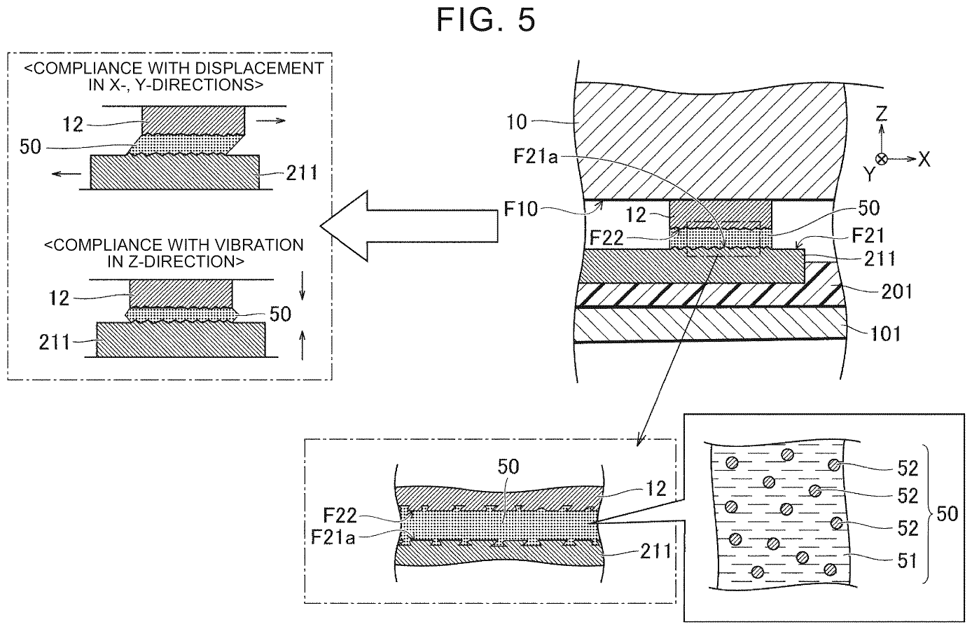

FIG. 5 illustrates the joint between the power storage cell 10 and the wiring board 200. FIG. 5 shows, as a representative example, the structure of the joint between one electrode terminal (electrode terminal 12) and one conductor member (conductor member 211). The other joints (more specifically, each joint between the electrode terminal of the power storage cell 10 and the conductor member of the wiring board 200) have the same structure.

As shown in FIG. 5, on a surface F21 of the conductor member 211 on the +Z-side, a portion (surface F21a) facing the electrode terminal 12 has minute projections and recesses by the above roughening treatment. The surface F21a has a greater surface roughness than the surrounding area. A surface F22 of the electrode terminal 12 on the −Z-side also has minute projections and recesses by the above roughening treatment. As shown in the enlarged view at the lower part of FIG. 5, the conductive adhesive 50 has solidified (cured) while penetrating into the minute projections and recesses formed on each of the surfaces F21a and F22. The surface roughness of the surface F22 may be greater than the surface roughness of the surface F21a. Alternatively, the surface roughness of the surface F21a may be greater than the surface roughness of the surface F22. Alternatively, these surfaces may have approximately the same surface roughness. The surface roughness is expressed, for example, by the arithmetic mean roughness (Ra). However, the present disclosure is not limited to this, and the surface roughnesses of the surfaces F21a and F22 may be compared in terms of the maximum height (Rz).

The conductive adhesive 50 contains a binder 51 and a plurality of filler particles 52 dispersed in the binder 51. The binder 51 contains, for example, resin. Each of the filler particles 52 has electrical conductivity. The conductive adhesive 50 having such a configuration has high compliance with displacement in the X-direction, displacement in the Y-direction, and vibration in the Z-direction as shown on the left side of FIG. 5. This facilitates maintaining the connection between the electrode terminals of the power storage cells 10 and the conductor members of the wiring board 200 even after the power storage device B is mounted on a vehicle.

The binder 51 may contain at least one of an epoxy resin, a phenol resin, an acrylic resin, a urethane resin, and a silicone resin. Using the epoxy resin or the phenol resin as the binder 51 facilitates increasing the heat resistance of the conductive adhesive 50. Using the acrylic resin, the urethane resin, or the silicone resin as the binder 51 facilitates increasing the compliance of the conductive adhesive 50. The filler particles 52 may include at least one of gold particles, silver particles, copper particles, nickel particles, and carbon particles. From the viewpoint of weight reduction, carbon particles are particularly preferred.

The conductive adhesive 50 is, for example, a heat-reactive curable conductive adhesive. However, the present disclosure is not limited to this, and the conductive adhesive 50 may be a dry-curable conductive adhesive or a two-liquid conductive adhesive (a conductive adhesive that is cured by a curing agent).

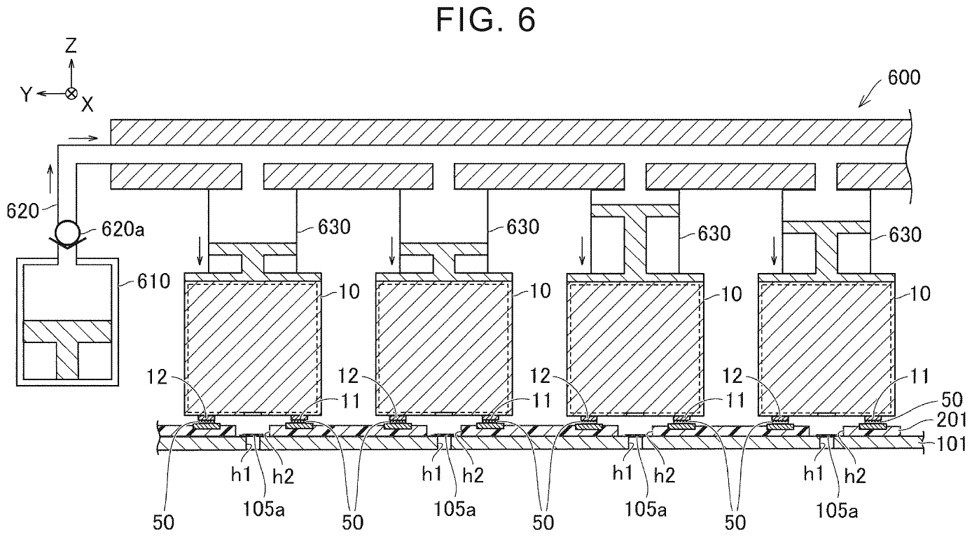

In mounting each power storage cell on the wiring board 200, an uncured conductive adhesive 50 is applied to the joint of each conductor member of the wiring board 200 (e.g., the surface F21a shown in FIG. 5), and then the power storage stacks S1 to S6 are placed on the wiring board 200. The conductive adhesive 50 is cured while pressure toward the wiring board 200 is evenly applied to each power storage cell, for example, by a pressure equalization device 600 shown in FIG. 6. As a result, the electrode terminals of each power storage cell and the conductor members of the wiring board 200 are connected via the conductive adhesive 50. FIG. 6 illustrates a method for connecting the power storage cells 10 and the wiring board 200 according to the present embodiment.

Referring to FIG. 6, the pressure equalization device 600 includes an oil supply device 610, a pipe 620, a check valve 620a, and a plurality of hydraulic cylinders 630. The hydraulic cylinder 630 is provided for each power storage cell. Specifically, the hydraulic cylinder 630 is provided on the +Z-side end face of each of the power storage cells included in the power storage stacks S1 to S6. Each of the hydraulic cylinders 630 receives oil from the common oil supply device 610 and pressurizes the corresponding power storage cells toward the −Z-side (wiring board 200 side). The oil supply device 610 and the hydraulic cylinders 630 are connected to each other via the common pipe 620. The oil supply device 610 supplies oil to each hydraulic cylinder 630 through the pipe 620 until a predetermined hydraulic pressure is applied to each hydraulic cylinder 630. The check valve 620a provided in the pipe 620 maintains the hydraulic pressure for each hydraulic cylinder 630 at a predetermined pressure. This maintains a state in which equal hydraulic pressures are applied to the hydraulic cylinders 630. In this state, the conductive adhesive 50 at each joint is cured.

Thus, the distance in the Z-direction between the electrode terminal of the power storage cell and the conductor member of the wiring board 200 at each joint is made uniform, and the thickness and density of the conductive adhesive 50 at each joint are made uniform. This configuration facilitates maintaining the connection between the electrode terminal of the power storage cell 10 and the conductor member of the wiring board 200 at each joint.

The various features of the power storage device described above (the features described in the embodiment and the modifications) may be applied in any combination.

The power storage device may be used for any purpose. The power storage device may be used in vehicles other than automobiles, mobile machines (such as agricultural machines and construction machines), unmanned moving objects, robots, or buildings.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. A power storage device comprising a first power storage cell, a second power storage cell, and a conductor member, wherein:
each of the first power storage cell and the second power storage cell includes an electrode terminal near the conductor member; and
each of the electrode terminal of the first power storage cell and the electrode terminal of the second power storage cell is connected to the conductor member via a conductive adhesive.

2. The power storage device according to claim 1, wherein:
the first power storage cell and the second power storage cell are arranged in a direction perpendicular to a vertical direction; and
each of the electrode terminal of the first power storage cell and the electrode terminal of the second power storage cell is connected to the conductor member while being oriented vertically downward.

3. The power storage device according to claim 2, further comprising an upper cover, a lower case, a common panel, a wiring board, and a cooler, wherein:
the first power storage cell, the second power storage cell, and the wiring board are housed between the lower case and the upper cover;
the wiring board includes a wiring pattern provided by a plurality of conductor members including the conductor member;
the cooler is disposed between the first power storage cell and the second power storage cell;
each of the first power storage cell and the second power storage cell further includes an exhaust valve on a surface provided with the electrode terminal; and
an exhaust passage is provided between the lower case and the common panel.

4. The power storage device according to claim 1, wherein, on a surface of the conductor member, a first portion to which the electrode terminal of the first power storage cell is connected and a second portion to which the electrode terminal of the second power storage cell is connected have been subjected to roughening treatment.

5. The power storage device according to claim 4, wherein:
a first surface of the electrode terminal of the first power storage cell has been subjected to roughening treatment, and the first surface is connected to the first portion of the conductor member via a first conductive adhesive; and
a second surface of the electrode terminal of the second power storage cell has been subjected to roughening treatment, and the second surface is connected to the second portion of the conductor member via a second conductive adhesive.
